(19) United States
(12) Patent Application Publication
(10) Pub. No.: US 2010/0143196 A1
(43) Pub. Date: Jun. 10, 2010

(54) MICROCANTILEVER SENSOR FOR ANALYTE DETECTION

(76) Inventors: James Patrick Reed, Redwood City, CA (US); Ray Stewart, Redwood City, CA (US)

Correspondence Address: King & Spalding LLP, P.O. Box 889, Belmont, CA, 94002-0889, US

(21) Appl. No.: 12/526,936

(22) PCT Filed: Jan. 18, 2008
(86) PCT No.: PCT/US08/00662

§ 371 Date: Jan. 25, 2010

Related U.S. Application Data
(60) Provisional application No. 60/901,220, filed on Feb. 13, 2007.
(60) Provisional application No. 60/926,458, filed on Apr. 27, 2007.

(51) Int. Cl. G01N 30/96; B32B 37/00

(52) U.S. Cl. 422/82.02; 156/64; 156/60

(57) ABSTRACT

Microcantilever sensors having protected microcantilever arms are described. The sensors are well suited for analyte detection and measuring other small movements. The protected arm reduces damage due to handling and assists in assembly of the microcantilever sensor with a transducer.

### CROSS-REFERENCE TO RELATED APPLICATIONS

This application claims the benefit of U.S. Provisional Application No. 60/901,220, filed Feb. 13, 2007 and; U.S. Provisional Application No. 60/926,458, filed Apr. 27, 2007, all of which are incorporated herein by reference in its entirety.

### STATEMENT REGARDING GOVERNMENT INTEREST

This work was supported in part by a U.S. Army Small Business Innovation Research Grant No. DAMD17-03-C-0013. Accordingly the United States government has certain rights in this invention.

### TECHNICAL FIELD

The subject matter relates to piezoresistive microcantilever sensors for detecting movement. The sensors have protected cantilevers to minimize damage, for example, due to handling and/or to assist in assembling the device with a transducer. The sensor may be used, for example, to detect a volume change in a sensor material resulting from exposure to an analyte.

### BACKGROUND

Chemical or “analyte” sensors typically employ a sensor material that is physically or chemically modified in the presence of an analyte in combination with a sensor device capable of detecting the physical or chemical modification. Such sensor devices include resistance/conductivity sensors, which are generally known as chemiresistors; optical sensors, sound acoustic wave sensors (SAWS), microelectromechanical systems, or MEMS sensors, and other types of sensors.

The general principles behind chemiresistors were demonstrated as early as 1986, when metal ion-phthalocyanine films spread on the surface of interdigitated electrodes showed a change in resistance in response to organic analyte vapor. Charge flows more easily when atoms in the sensor are brought together and less easily when the atoms are moved apart, which is accomplished by reversibly “swelling” the sensor with analyte or “shrinking” the sensor by removing analyte.

More recent analyte sensors contain organic polymers. Analytes typically diffuse into the polymer matrix, thereby changing the conductivity of the polymer by swelling or contracting the matrix and changing either the distance between conductive atoms or the pathway taken by the mobile charge. Organic polymer-based sensors are described in, e.g., Lonergan et al. (1996) Chem. Mater. 8:2298-2312; Doleman et al. (1998) Anal. Chem. 70:4177-4190. The sensors have used in a variety of applications and devices, including those described in U.S. Pat. No. 5,571,401.

Metal, semiconductor, and magnetic particles can also be included in the sensors to enhance the sensitivity to resistance changes in the material when the volume of the polymer changes. Conductive or semi-conductive particles may be in the form of small particles, such as nanoparticles, and dispersed in the polymer matrix. These particles are often referred to as an “inorganic” component, as opposed to the “organic” polymer component. Various chemical sensors have been developed based on theses organic/inorganic composite sensors (e.g., Evans et al. (2000) J. Mater. Chem. 8:183-188; Wohltjen and Snow (1998) Anal. Chem. 70:2856-2859; WO 00/00808; WO 00/33062; and WO 99/08105.)

A particular form of chemical sensors formed of organic matrices are sensors made using organic dendritic compounds. These compounds are unique in their ability to take up guest molecules, and have been used to prepare coatings for mass-sensitive chemical sensors. Dendritic sensors can also include metal particles. These sensors are exemplified in, e.g., Wells and Crooks (1996) J. Am. Chem. Soc. 118:3988-3989; WO 97/39041; Sooklal et al. (1998) Adv. Mater. 10:1083-1087; Garcia et al. (1999) Anal. Chem. 71:256-258.

In some cases, the exposure of a sensor material to an analyte changes the charge density in the material, allowing detection using a suitable electronic device (e.g., a voltmeter, ohmmeter, etc.). In other cases, swelling of the sensor material in response to an analyte can be detected using a MEMS sensor. A particular MEMS sensor that is well-suited to detecting small movements is an embedded piezoresistive microcantilever (EPM) sensor. These sensors provide a small, low-cost, and simple platform for the rapid detection of a variety of analytes, which produce a volumetric change in a sensor material.

In the basic EPM sensor, a piezoresistive microcantilever is embedded, partially embedded, or in contact with a in a sensing material. In the presence of an analyte the sensing material undergoes a volumetric change which can be measured as a change in resistance or change in voltage, depending on how the EPM sensor is configured. Cantilever deflections of only a few angstroms are measurable using EPM devices.

Electronics for EPM sensors are known in the art, the electronics being capable of measuring the cantilever resistance during a sensing event. For example, a single-chip AD7793 24-bit A-D converter which functions as a 6½ digit multimeter may be used to directly measure the cantilever resistance. Alternatively, a Wheatstone bridge (with the cantilever occupying one arm of the full-bridge) coupled to an instrumentation amplifier and an A-D converter may be used to directly measure the cantilever resistance. Microcantilevers are described in U.S. Pat. Nos. 6,523,392, 6,823,717, and 6,854,371, and U.S. Patent Publications 2005/0164299 and 2006/0053871, the entire documents of which are incorporated herein by reference.

EPM sensors have been suggested for use in a variety of sensing applications with a variety of different analytes. Such applications include detecting volatile organic compounds (VOCs) (Porter et al. (2000) Scanning 22:1-5; Porter et al. (2003) Ultramicroscopy 97:365-369), detecting chlorinated hydrocarbons (e.g., in a water and vapor phase), detecting personal hydration levels (Gunter et al. (2005) Med. Eng. Phys. 27:215-220), detecting carbon monoxide gas (Kooser et al. (2004) Sens. Actuators B99:430-433), detecting single-strand DNA (Gunter et al. (2004) I.E.E.E. Sensors 4:430-433), detecting proteins (Kooser et al. (2003) Biosens. Bioelectron. 19:503-508), and detecting viruses (Gunter et al. (2003) Sens. Actuators A107:219-224).

Microcantilever-based sensors may operate as static coated devices (Baselt (1996) J. Vac. Sci. Technol. 14:789-793; Thundat et al. (1994) Appl. Phys. Lett. 64 (1994) 2894-96, vibrating cantilever devices Thundat (1995) Anal. Chem. 67:519-21, contact-mode devices (Porter et al. (2001) Sens, Actuators A88:47-51; Porter et al. (2000) Scanning 22:1-5), or embedded sensors (Porter et al. (2003) Ultramicroscopy 97:365-69). Both standard (inert) and piezoresistive cantilevers have been used in various sensing applications.

EPM sensors are delicate devices, which are easily damaged during manufacturing and handling, particularly during the positioning of the cantilever on (or in) the sensor material. The need exists for more robust and sensitive EPM sensors and for improved methods of making and assembling such sensors.

### BRIEF SUMMARY

The following aspects and embodiments thereof described and illustrated below are meant to be exemplary and illustrative, not limiting in scope.

In one aspect, a microcantilever sensor for detecting movement in a transducer is provided, then sensor comprising a substantially solid body having an opening, and a microcantilever arm protruding into the opening, wherein the microcantilever arm is protected from damage by the body of the sensor.

In some embodiments, the sensor further comprises a piezoresistive element attached to the cantilever arm for contacting the transducer.

In some embodiments, the cantilever arm in the opening is recessed below the surface of the body.

In some embodiments, the sensor further comprises a transducer comprising an analyte sensor material.

In some embodiments, the sensor is adapted for receiving a transducer attached to a plug for insertion into the opening, wherein the transducer contacts the piezoresistive element.

In some embodiments, the sensor is adapted for receiving a transducer attached to a plate for mounting over the opening, wherein the transducer contacts the piezoresistive element.

In some embodiments, the body is made of silicon. In further embodiments, the cantilever arm is made of silicon.

In some embodiments, the cantilever arm and the body are continuous. In other embodiments, the cantilever arm and the body are integrally formed. In particular embodiments, the cantilever arm is released from the body of the sensor by masking and etching.

In another aspect, a method for assembling a microcantilever sensor and transducer element is provided, the method comprising providing a microcantilever sensor having a protected microcantilever arm protruding into an opening in a body; inserting a plug, having attached thereto the transducer, into the opening in the body, wherein contact between the transducer and the microcantilever produces a change in the output of the microcantilever sensor; monitoring the output of the microcantilver sensor, and when the output of the microcantilever sensor changes upon the contacting of the transducer and the cantilever arm, fixing the plug to the body.

In some embodiments, the microcantilever has attached thereto a piezoresistive element, and the piezoresistive element contacts the transducer.

In some embodiments, the plug is fixed to the body using adhesive.

In another aspect, a method for assembling a microcantilever sensor and transducer element is provided, the method comprising providing a microcantilever sensor having a protected microcantilever arm protruding into an opening in a body, inserting a plug, having attached thereto the transducer, into the opening in the body, wherein the plug is dimensioned to allow contact between the transducer and the microcantilever when the plug is fully inserted into the opening.

In particular embodiments, the body is silica.

In some embodiments, the plug is molded from a non-deformable material.

In yet another aspect, a method for assembling a microcantilever sensor and transducer element is provided, the method comprising providing a microcantilever sensor having a protected microcantilever arm protruding into an opening in a body and recessed below the surface of the body, and affixing a plate, having attached thereto the transducer, over the opening in the body, to allow contact between the transducer and the microcantilever.

In some embodiments, the body is silicon. In some embodiments, the plate is silica. In particular embodiments, the plate is affixed using adhesive.

In addition to the exemplary aspects and embodiments described above, further aspects and embodiments will become apparent by reference to the drawings and by study of the following descriptions.

### BRIEF DESCRIPTION OF THE DRAWINGS

FIG. 1A is a micrograph of an exemplary piezoresistive microcantilever device, in plan view.

FIGS. 1B-1D are drawings showing the side views of different embodiments of the microcantilever device, having different microcantilever placement in the opening.

FIGS. 2A-2E are drawings illustrating steps in a method of releasing the microcantilever from the substrate, in side view.

FIGS. 3A-3B are drawings showing the installation of a plug having a transducer attached on the top surface, in side view. The resistance of the piezoresistive element may be monitored during installation of the plug.

FIGS. 4A-4D are drawings illustrating different plug embodiments, in side view.

FIGS. 5A-5C are drawings illustrating an embodiment having a protected and recessed cantilever, as in FIG. 1D, for use with a plate or cover having an attached transducer. The drawings are in side view.

FIG. 6 is a graph showing the response of an EPM sensor over time to the reaction of KCN with H₂SO₄, which caused the sensor to initially be exposed to 600 ppm HCN. The arrow indicates commencement of the HCN-producing reaction between KCN and H₂SO₄.

FIG. 7 is a graph showing the response of an EPM sensor over time to two consecutive exposures of approximately 150 ppm HCN, with each 150 ppm HCN generated by a reaction of KCN with H₂SO₄. The arrows indicate the times at which each reaction that produced HCN commenced.

FIG. 8 is a graph showing the response of an EPM sensor over time to a single exposure of H₂SO₄. The arrow indicates the time at which the acid was injected.

### DETAILED DESCRIPTION

The present microcantilever device features a protected cantilever arm to reduce accidental damage to the cantilever and to assist in the assembly of the microcantilever device with a transducer. Where conventional microcantilever devices are fragile and easily broken by manual handling and assembly with a transducer, the present device is more robust, allowing an analyte sensor to be assembled more quickly and without breakage. The present microcantilever device is also exquisitely sensitive, allowing the detection of low concentrations of analyte. These and other aspects and features of the present microcantilever device are described below, with reference to the accompanying illustrations.

### I. EPM Sensor Device

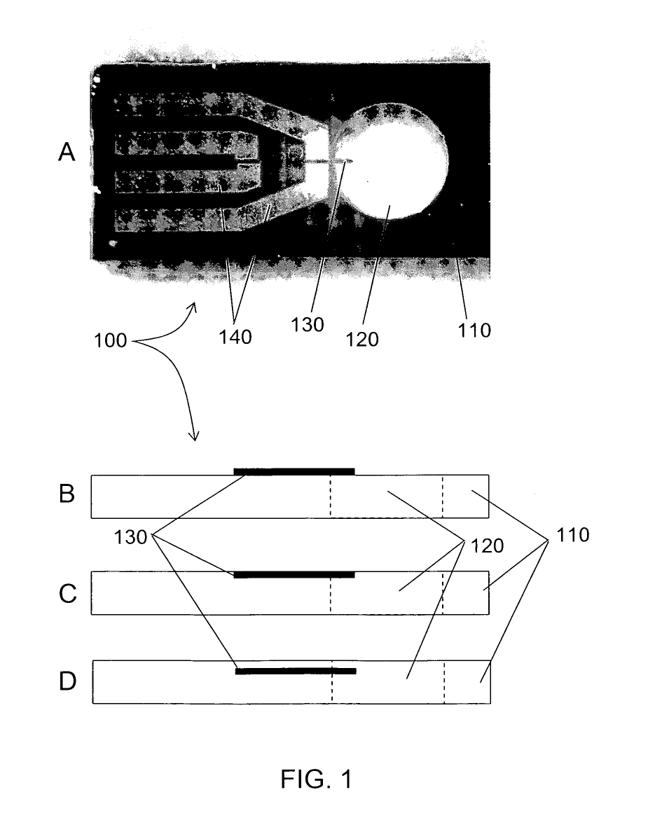

An exemplary microcantilever device is illustrated in FIGS. 1A-1D. FIG. 1A is a photograph/micrograph showing a plan view of an exemplary microcantilever device 100. FIGS. 1B-1D are drawings showing side views of different embodiments of a microcantilever device 100 similar to that in FIG. 1. Common identification numbers are used throughout FIG. 1.

The substrate (or base) 110 of the microcantilever device 100 is made from a substantially solid material such as silica or a polymer, including but not limited to acetal, acrylic, phenolic, urethane, epoxy, nylon, polystyrene, polycarbonate, high density polyethylene, polyvinyl chloride, and the like. The polymer should be rigid, so it does deform in response to the changing shape of the polymeric material, and stable, so it does not swell, dissolve, or otherwise change dimensions in the presence of the analyte. Silica is both rigid and stable in the presence of various analytes.

A feature of the present microcantilever device 100 is that the microcantilever 130 is protected by the substrate 110. In particular, the microcantilever 130 extends into an opening 120 in the substrate 110, wherein the surrounding substrate protects the microcantilever 130 from physical damage, e.g., caused by handling. As shown in FIGS. 1B-1D, the microcantilever 130 may be mounted on the surface of the substrate (FIG. 1B), flush with the surface of the substrate (FIG. 1C), or below the surface of the substrate (i.e., recessed; FIG. 1D).

The substrate 110 may provide electrical connections 140 for the microcantilever 130, similar to those of a printed circuit board (FIG. 1A). In this manner, the analyte sensor is readily integrated with other electronic devices using, e.g., a press-on electrical connector with the appropriate number of terminals.

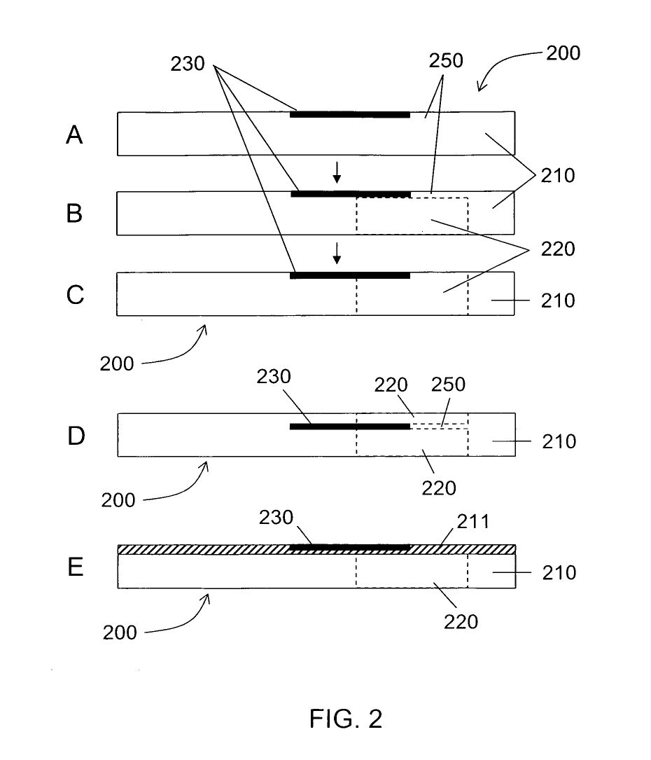

In addition to protecting the microcantilever from damage, the present microcantilever device offers advantages in terms of efficient assembly with transducers. First, as shown in the side views of FIGS. 2A-2C (and FIGS. 1A-1D), the microcantilever device 200 can be manufactured from a single piece of substrate 210, where the cantilever 230 emerges from the substrate 210 after unwanted material has been removed. The cantilever 230 is shown in a different color from the substrate 210 for illustrative purposes only (FIGS. 2A-2C).

According to this method of manufacturing, the starting substrate 210 in FIG. 1A is typically drilled, laser cut, or chemically etched to create an opening 220, defined by the broken lines (FIG. 2B). In some embodiments, the opening does not traverse the substrate 210 (as in the case of a through-hole) but instead leaves a portion 250 of the original substrate 210 remaining. In some examples, the thickness of the remaining portion 250 of the substrate 210 is about the same as that of the cantilever 230. After masking the remaining portion 250 of the substrate 210 and removing additional material (FIG. 2B), the cantilever 230 emerges from the substrate 210 (FIG. 2C), producing, e.g., a microcantilever device as shown in FIG. 1A. Since the substrate 210 and cantilever 230 may be a continuous piece of material, the microcantilever 230 is rigidly attached to the substrate, allowing the device to be exquisitely sensitive to pressure.

In the case of the embodiment shown in FIG. 1D, wherein the cantilever 130 is positioned below the surface of the substrate 110, the opening 120 may be cut or etched from either or both sides of the substrate, rather than from one side as illustrated in FIGS. 2B and 2C. In all embodiments, the substrate may be laminated, such that the cantilever emerges from a particular layer 211 of material. For example, the remaining substrate 250 shown in FIGS. 2A-2C may be of a different material 211 than the substrate 210 cut by the drill or laser, as illustrated in FIG. 2E.

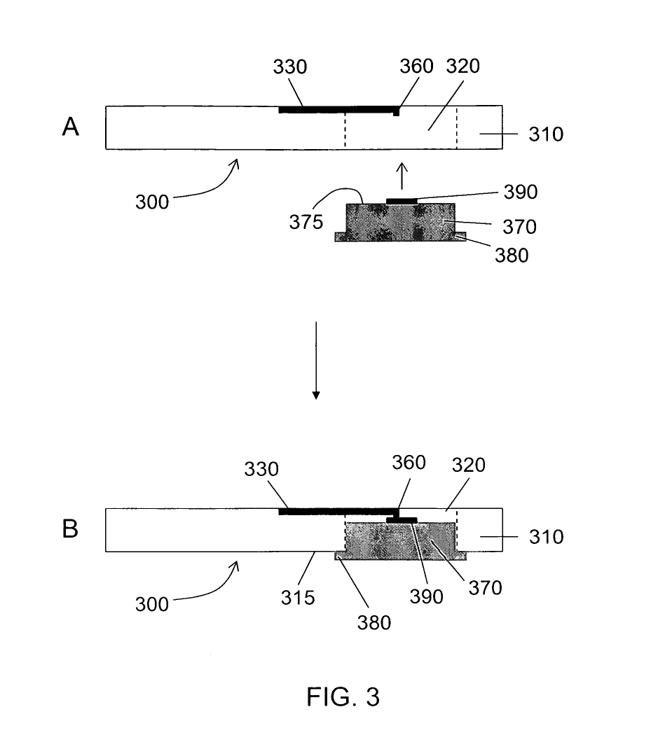

As shown in FIGS. 3A and 3B, the design of the microcantilever device 300 allows the transducer 490 to be installed from the back of the substrate 310, minimizing the chance of damaging the microcantilever 430 during assembly and ensuring the accurate placement of the transducer 490 under the cantilever 430. The microcantilever device 300 is essentially as before except that the piezoresistive element 360 is shown. A plug 370 having a top surface 375, a base 380, and having the transducer element 390 attached to the top surface 375, is introduced into the opening 320 in the substrate 310, as shown in FIG. 3A. In some embodiments, the opening and plug are essentially round and the plug 370 fits snuggly into the opening 320.

The plug 370 is shown inserted in the substrate in FIG. 3B. In some embodiment, the plug 370 is inserted until the plug base 380 contacts the bottom surface 315 of the substrate, which places the transducer 390 in contact with the piezoresistive element 360. In other embodiments, the plug 370 is inserted into the substrate 310 while the resistance of the piezoresistive element 360 is monitored (as it would be in normal operation, e.g., detecting an alalyte). In this embodiment, the plug 370 is inserted into the substrate 310 until the transducer contacts the piezoresistive element 360, thereby causing the resistance of the piezoresistive element 360 to change. The plug 370 is then fixed into the opening 320, e.g., by applying adhesive around the plug base 380.

In this and other embodiments, the adhesive may be an epoxy, silicone, urethane, cyanoacrylate, acrylic, anaerobic, hot-melt, or solvent based adhesive. In some embodiments, the adhesive is UV-curable to allow the rapid curing of the adhesive with UV light after the transducer contacts the piezoresistive element.

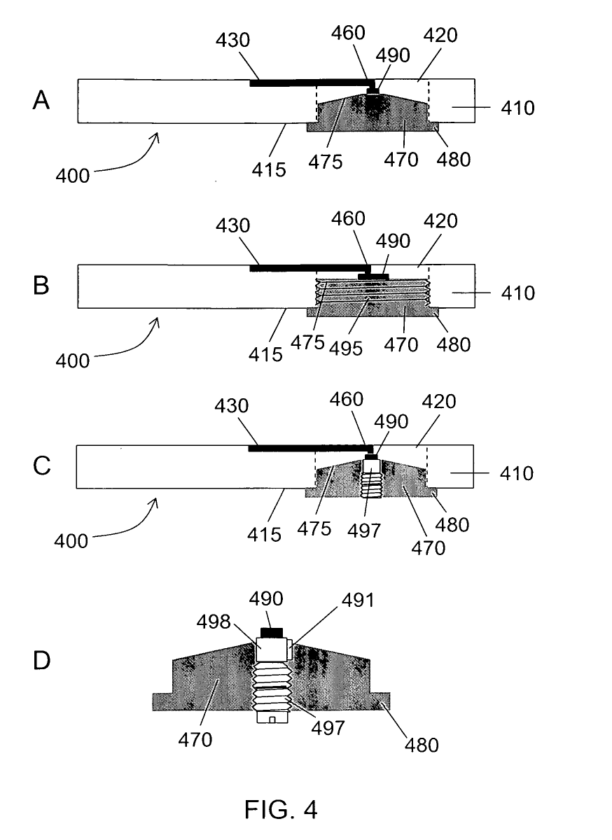

FIGS. 4A-4C show several other embodiments of a plug 470 for use in a microcantilever device 400. The substrate 410, opening 420, microcantilever 430, and piezoresistive element 460 are similar to those in FIGS. 3A and 3B. In the embodiment shown in FIG. 4A, the plug 470 has a tapered top surface 475 for attaching the transducer 490. The tapered surface assures that no part of the plug 470 or transducer 490 contacts the microcantilever 430 near its fulcrum 435.

In the embodiment shown in FIG. 4B, the substrate 410 and plug 470 have matching threads 495, allowing the plug 470 to be threaded in to the substrate 410. According to this embodiment, the plug 470 may be threaded into the substrate 410 until the transducer 490 contacts the piezoresistive element 460, changing the resistance (as determined by monitoring the resistance during assembly, as above). The plug 470 may then be fixed in place, e.g., as before. This embodiment also provides adjustability in the microcantilever device 400, e.g., allowing it to accept transducers 490 having different dimensions.

The embodiment shown in FIG. 4C combines features of the embodiments of FIGS. 4A and 4B. Here, a plug 470 with a tapered upper surface 475 presses into the substrate 410. A threaded adjustment 497 in the plug 470 allows the position of the transducer 490 to be adjusted after insertion of the plug 470. In preferred embodiments, the adjustment 497 and plug 470 have matching fine threads, to allow accurate placement of the transducer.

In all embodiments, the plug is preferably made of a substantially rigid material, such that the plug does not distort as the transducer changes shape. In some embodiments, the plugs are machined, e.g., from aluminum, acetal, epoxy, polystyrene, polycarbonate, and other materials suitable for making the substrate. In other embodiments, the plugs are molded from the same or different materials. Threaded plugs may required additional machining or mold details.

It may be desirable in some embodiments to provide a threadable, adjustable plug having a thread adjustment 497 that contacts a non-rotating plug 498 (FIG. 4D). The non-rotating plug 498 may include a protrusion 491 that engages a corresponding groove in the substrate 410, allowing the non-rotating plug 498 to move up and down with respect to the microcantilever 430 but preventing the plug from rotating, thereby avoiding twisting the transducer 490 against the microcantilever 430 during adjustment.

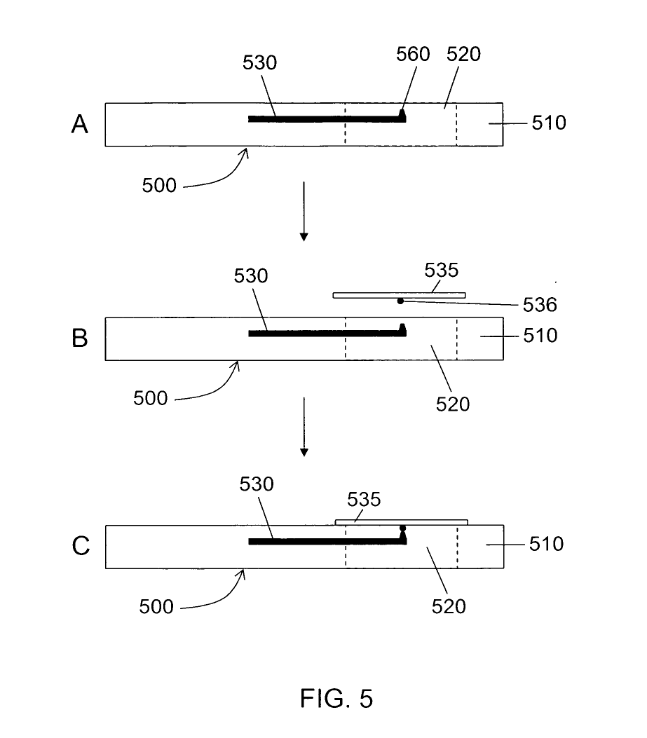

The embodiment shown in FIGS. 5A-5C has a protected and recessed cantilever arm 530 similar to the embodiment shown FIG. 1D (FIG. 5A). The cantilever arm protrudes into the opening 520 and is recessed below the surface of the body 510. The position of the cantilever arm 530 and attached piezoelectric element 560, allow the placement of a plate (or cover) 535, having attached thereto a transducer 536 (FIG. 5B). Once the cover 535 is in place (FIG. 5C), the transducer 536 and piezoelectric element 560 are properly positioned to detect a volume change in the transducer. In some embodiments, the piezoelectric element 560 just contacts the transducer 536. In other embodiments, the piezoelectric element 560 is preloaded against the transducer. The cover 535 may be glued in place or otherwise secured to the body 510 of the device 500. In further embodiments, the cover feature illustrated in FIG. 5 is combined with an adjustable or non adjustable base, as described above.

In all embodiments, the transducer should contact or slightly preload the piezoelectric element (or naked microcantilever arm) once properly assembled. A gap between the piezoelectric element and transducer generally interferes with the function of the sensor, since the transducer will swell before movement is detected by the piezoelectric element.

The EPM sensor may be provided as a miniaturized sensor-electronics package, including integration of the package into a multi-hop wireless network of “motes”. The combination of small, simple EPM sensors with battery powered wireless motes may eventually find worthwhile field applications in the sensing of many analytes, including poisons such HCN or other dangerous or environmentally important chemicals or vapors.

### II. Transducer Elements

The present microcantilever sensors can be used with many transducers, including those described herein and other transducers known in the art. While the microcantilever sensors have been described mainly with respect to analyte detection, the sensors are generally useful for detecting small movements and in no way limited to the present exemplification.

Experiments performed to demonstrate the functioning of the microcantilever sensor used a transducer (i.e., sensor material) comprising a polymeric matrix having embedded nanoparticles. Upon exposure to analyte, the analyte competes with the polymer matrix for interaction with the particles, thereby reducing the amount of interaction between the polymer matrix and the particles, and increasing the free volume of the polymer matrix. The increased free volume of the polymer matrix results in a volumetric change in the sensing material, which was measured using an embodiment of the present microcantilever device. The particular sensor material comprised a keratin matrix functionalized with thiolated gold nano-particles as a sensing material, which was able to detect hydrogen cyanide gas.

### III. Exemplary Microcantilever EPM Sensors

Preparation and testing of an exemplary microcantilever EPM sensor is described in Examples 1-3. The sensor was used to detect HCN gas evolved upon adding acid to a cyanide salt. Movement of the cantilever arm away from the sensor material, as in the case of a volumetric increase of the sensor material, resulted in detectable resistance in the EPM device, which in this case was detected as a reduced voltage.

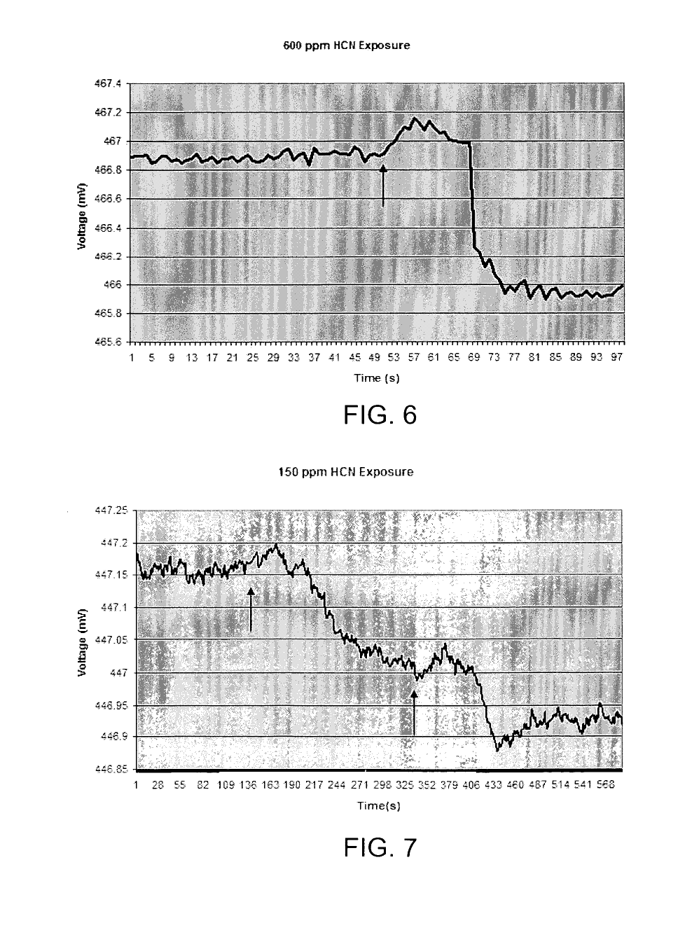

FIG. 6 shows the response of the sensor material following exposure to about 600 ppm HCN. The arrow indicates the time (49 seconds) at which H₂SO₄ was dropped into KCN powder to evolve HCN gas. Within a few seconds, the sensor voltage initially rises. Approximately 20 seconds following this increase voltage, the sensor voltage decreases, leveling off about 25 seconds following the addition of H₂SO₄. The cantilever voltage decreased to well below the starting level, indicating that the cantilever was bending away from the sensor material due to a volumetric increase of the sensor material. The net voltage change from the initial reading to the final reading was approximately 1 mV (i.e., about 467 mV-466 mV). Given a cantilever sensitivity of approximately 4.7 Ω/μm, the estimated net cantilever deflection (based on current measurement) from the initial position to the final position was 1 μm. Subsequent exposures to similar amounts of HCN result in no sensor response, suggesting that at such a high concentration of HCN, the sensor acted as a chemical fuse that provided a one-time signal.

The initial rise in sensor voltage following exposure to HCN suggests that the cantilever may have “unloaded” some of the initial “pre-load” (pre-strain) introduced during the assembly of the sensor, corresponding to the cantilever bending back toward (or into) the sensor material. This type of cantilever response to the HCN analyte, i.e., in which the initial response is reduced deflection, followed by a subsequent larger increased deflection, has been observed by previously in systems that respond rapidly to analytes (Gunter et al. (2005) Med. Eng. Phys. 27:215-220). There is no adequate explanation for this behavior, as it is not predicted by standard models describing the diffusion or partitioning of analyte molecules into a polymer or other host matrices (Cussler (1997) Cambridge University Press).

Without being bound to theory, it is postulated that two separate events are occurring. First, a rapid response event, which may largely be confined to the surface of the sensing material, may initially be occurring. The initial response may be due to adsorption, absorption, or rapid protonation of the keratin by the HCN. Keratin disulfide cross-links may also be broken. These responses may represent a rapid “melting” of the material in the top-most layers of the sensing material. Second, a slower, and ultimately larger response may be due to the bulk diffusion of the analyte into, and subsequent chemical reaction of the HCN molecules with, the particles, thereby displacing the keratin polymer and increasing the free volume of the sensor material.

As shown in FIG. 7, the EPM sensor was also able to detect HCN an exposure of approximately 150 ppm. As indicated by the arrows, the first addition of H₂SO₄ to KCN was at 139 seconds, as indicated by the first arrow. As with the earlier exposure, the initial sensor response was an increase in voltage followed by a decrease in sensor voltage. The net voltage change from initial reading to final reading was approximately 0.15 mV, or ⅙ of the previous 600 ppm-voltage response. The estimated net cantilever deflection from prior to exposure to end was 0.16 μm. It is expected that the net cantilever response for the 150 ppm exposure would be approximately ¼ of the response of the 600 ppm exposure instead of ⅙. Since the present sensors are assembled by hand, there may be small variations from one sensor to the next in sensing material layer thickness, in microcantilever pre-straining, and in percent of cantilever length that is embedded in the sensing material.

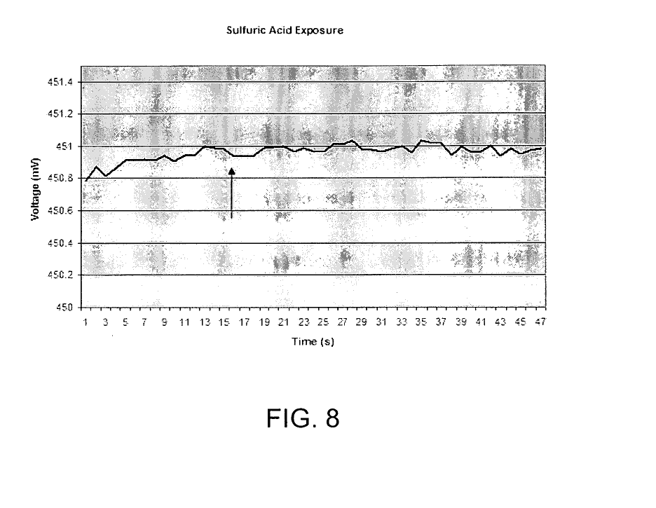

The sensor was exposed a second time to 150 ppm HCN at 335 seconds, as indicated by the second arrow on FIG. 7. Here, the sensor was able to react a second time to the presence of HCN, indicating that the first exposure to 150 ppm did not “exhaust” the detection capability of the sensor material. The second net sensor voltage response was approximately 0.1 mV, or about 35% less than that of the first exposure. A similar EPM sensor as used in the experiment of FIG. 7 was exposed to H₂SO₄ vapors only, in the absence of KCN (FIG. 8). The arrow indicates the time at which the acid was introduced to a chamber including the sensor device. The amount of H₂SO₄ vapor was similar to that used in the higher concentration HCN (i.e., 600 ppm) experiment, described above and in the Examples. As shown in FIG. 4, H₂SO₄ by itself had no significant effect on the sensor or sensor material, demonstrating that in the previous experiments the sensor material responded to HCN.

These described results are reproducible across other sensors. HCN detection signals currently vary 10-20% from one sensor to the next. Automated production will likely improve reproducibility. The results demonstrate that the EPM sensor with a protected cantilever is effective in detecting the volume change of an analyte sensor material upon exposure to analyte. More generally, the results demonstrate that a protected cantilever device can be used assemble sensitive transducer devices with a high level of sensitivity for small movements.

### EXAMPLES

The following examples are illustrative in nature and are not intended to be limiting. The following definitions are provided for clarity. Abbreviations not specifically defined should be accorded their ordinary meaning as used in the art.

| | |
|---|---|
| M | Molar |
| mM | Millimolar |
| nM | Nanomolar |
| m | Meter |
| mm | Millimeter |
| μm | Micrometer |
| nm | Nanometer |
| Ω | Ohm |
| kΩ | kiloOhm |
| ppm | parts per million |
| V | Volt |
| mV | milliVolt |
| g | Gram |
| ° C. | degrees Celsius |
| mOsmol | milliosmolarity equivalents |

### Example 1

### Sensor Material to Detect Hydrogen Cyanide

An exemplary sensing material consisted of a keratin matrix in combination with thiolated colloidal gold particles. α-keratins assemble intermediate filaments by forming multiple disulfide cross-links among the molecules (Nelson and Cox (2005) Principles of biochemistry, W. H. Freeman and Co.). Alkanethiol monolayers form on gold surfaces by strong coordination of alkanethiol compounds to gold by self-assembly (Bain (1989) J. Am. Chem. Soc. 111:321-335; Nuzzo and Allara (1983) J. Am. Chem. Soc. 105:4481-4483; Whitesides and Laibinis (1990) Langmuir 6:87-96).

Keratin was mixed first with 2-mercaptoethanol to reduce disulfides to sulfhydryls, and then with colloidal gold to form a self-assembled matrix of nanogold-keratin via gold thiolate coordination. The source of keratin was VariKer 100 keratin powder (Variati and Company, Milan, Italy). Colloidal gold source was particles with a diameter of 20 nm in aqueous suspension (Sigma-Aldrich, St. Louis, Mo.). The keratin and colloidal gold were used in a 1:1 ratio, to form a liquid phase sensing material.

The liquid phase sensing material was deposited onto glass substrates, and the sensor microcantilever was brought into contact with the use of a micromanipulator. Only the last approximate ⅓ of the cantilever length was brought into contact with the sensing material. This assembly process allowed the cantilever to be partially “embedded” in the sensing material after drying. The nominal length of the cantilevers was 200 μm, with a width of 40 μm. Each cantilever die also contained an integrated thermistor for temperature measurement; however the thermistor component of these dies was not used in the current experiments.

The nominal resistance of the bare cantilevers before assembly was 2.2 kΩ. After material deposition and drying, the finished sensors exhibited resistances of approximately 2.15 kΩ, indicating that the cantilevers have been pre-strained an amount equivalent to 50 kΩ, and in the instant case, strained in a direction upward (away) from the sensor substrate. The amount of pre-straining (or pre-loading) varied slightly from one sensor to the next, owing to the manual deposition and assembly process.

The sensors were tested in a chamber of approximately 11 liters in volume. Production of HCN in the chamber was achieved by exposing a measured amount of KCN powder to 96% sulfuric acid (H₂SO₄), which produced K₂SO₄ and HCN gas (about 600 ppm; FIG. 1).

The colloidal gold entrained in the keratin reacted with the HCN and the ambient moisture of keratin hydration as:

4Au+8CN⁻+O₂+H₂O→4[Au(CN)₂]⁻+4OH⁻

This coordination of cyanide to the entrained gold, with the resulting displacement of the polymers and increase of their free volume, produced a measurable displacement of the cantilever sensor. During exposure, there was no flow of air in or out of the chamber, allowing better quantification of the HCN concentration in the chamber. After exposure, the chamber was vented with a dry nitrogen flow. The exhaust from the chamber was routed into an HCN scrubber prior to external venting. Additional experiments were performed using fresh sensors that were exposed to H₂SO₄ vapors only, and sensors lacking the polymer or particle component (see Example 3).

### Example 2

### Exposure of the Sensor Material to Different Concentrations of HCN

Sensor material as described in Example 1 was also exposed to lower levels of HCN and the increase in polymer volume was detected using an EPM sensor. FIG. 2 shows the initial response of the sensor material to an exposure of approximately 150 ppm HCN. H₂SO₄ was added to KCN to evolve HCN at 139 second, as indicated by the arrow. As with the experiments described in Example 1, the initial sensor response was an increase in voltage, indicating that the microcantilever moved toward (into) the sensor material. The initial increase in sensor voltage was followed by a decrease in voltage, as before. The overall time frame for the response to the 150 ppm exposure was about 210 second, or approximately 5 times the length on the response time for 600 ppm HCN. The net voltage change from initial reading to final reading was approximately 0.15 mV, or ⅙ of the previous 600 ppm voltage response. The estimated net cantilever deflection from prior to exposure to end was 0.16 μm. It is expected that the net cantilever response for the 150 ppm exposure would be about ¼ of the response of the 600 ppm exposure instead of ⅙ (see discussion, above).

The response of the same sensor material to a second exposure of 150 ppm HCN was measured. This exposure occurred at 335 seconds, as indicated by the second/additional arrow shown in FIG. 3. The sensor was able to react a second time to the presence of HCN, indicating that the first 150 ppm exposure did not “exhaust” the sensing capability of the sensor material. The net sensor voltage response in the second exposure was approximately 0.1 mV, or about 35% less than that recorded in the first exposure. These results are reproducible using other samples of sensors material, and HCN detection signals vary 10-20% from one sensor to the next. This variation may be attributable to differences in the thickness of the sensing layer from one sensor to the next, since the sensors are assembled by hand, including deposition of the sensing layer.

### Example 3

### Exposure of the Sensor to H₂SO₄ as a Negative Control

Similar sensor material to that used in Examples 2 and 3 was exposed to H₂SO₄ vapors only, in the absence of KCN. Here, the sensor was in the chamber when sulfuric acid was injected in through a rubber membrane with a syringe. The amount of acid vapor was similar to that present in the 600 ppm-experiment of Example 2. The results are shown in FIG. 8, with the arrow indicating the time at which the acid was injected. In comparing the sensor response to that shown in FIG. 2, it is apparent that H₂SO₄, by itself, had no significant effect on the sensor or sensing material.

While a number of exemplary aspects and embodiments have been discussed above, those of skill in the art will recognize certain modifications, permutations, additions, and sub-combinations thereof. It is therefore intended that the following appended claims and claims hereafter introduced are interpreted to include all such modifications, permutations, additions and sub-combinations as are within their true spirit and scope.

1. A microcantilever sensor, comprising:
(a) a substantially solid body having an opening and at least one surface,
(b) a microcantilever arm protruding into the opening, and
(c) a plug for insertion into at least a portion of the opening, the plug being in contact with a transducer,
wherein the transducer is disposed for contact with at least a portion of the microcantilever arm,
wherein the microcantilever arm is protected from damage by the body of the sensor.

2. The sensor of claim 1, further comprising a piezoresistive element attached to the microcantilever arm for contacting the transducer.

3. The sensor of claim 2, wherein the microcantilever arm in the opening is recessed below the surface of the body.

4. The sensor of claim 2, wherein the transducer further comprises an analyte sensor material.

5. The sensor of claim 2, wherein the transducer is disposed for contact with the piezoresistive element.

6. The sensor of claim 2, further comprising a plate for mounting over the opening.

7. The sensor of claim 2, wherein the body is made of silicon.

8. The sensor of claim 7, wherein the microcantilever arm is made of silicon.

9. The sensor of claim 8, wherein the microcantilever arm and the body are continuous.

10. The sensor of claim 9, wherein the microcantilever arm is released from the body of the sensor by masking and etching.

11. A method for assembling a microcantilever sensor and transducer element, the method comprising
(a) providing a microcantilever sensor having a protected microcantilever arm protruding into an opening in a body, and
(b) inserting a plug, having attached thereto the transducer, into the opening in the body, wherein the plug is dimensioned to allow contact between the transducer and the microcantilever sensor when the plug is inserted into the opening.

12. The method of claim 11, wherein the microcantilever has attached thereto a piezoresistive element, and the piezoresistive element contacts the transducer.

13. The method of claim 11, wherein the plug is fixed to the body using adhesive.

14. The method of claim 11, wherein contact between the transducer and the microcantilever sensor produces a change in the output of the microcantilever sensor, said method further comprising:
(c) monitoring the output of the microcantilever sensor during (b), and when the output of the microcantilever sensor changes upon contacting of the transducer and the cantilever arm, fixing the plug to the body.

15. The method of claim 11, wherein the plug is molded from a non-deformable material.
